(19) United States
(12) Patent Application Publication
(10) Pub. No.: US 2012/0305097 A1
(43) Pub. Date: Dec. 6, 2012

(54) TAPPING DEVICE WITH HAND PROTECTOR

(76) Inventor: Joseph Fiorini, Hopewell Jct, NY (US)

(21) Appl. No.: 13/151,427

(22) Filed: Jun. 2, 2011

(51) Int. Cl. B23B 25/04; F16L 41/04; B23B 45/14; B23B 41/08

(52) U.S. Cl. 137/15.14; 137/318; 408/710

(57) ABSTRACT

Tapping devices and methods for using such devices to tap into a pipe are described. The tapping device contains a drill connected to the proximal portion of a shaft, a tapping tool attached to a distal portion of the shaft, and a protection device attached to the shaft. The protection device itself contains containing an enlarged distal portion, an enlarged proximal portion, and a middle member extending therebetween. The user can hold and use the tapping device with a first hand on a handle of the drill and a second hand on the middle member of the protection device. The protection device protects the hand from hitting an object (including the pipe), the socket, or the drill, thereby improving the safety for the user. Other embodiments are also described.

### FIELD

This application relates generally to tapping devices and methods for using such devices to tap into a pipe. More specifically, this application relates to tapping devices that contain a hand protector that increases the safety of a user when tapping a gas pipe.

### BACKGROUND

Natural gas transmission and distribution companies often new to make new connections to pipelines after they have been installed. This helps the companies expand or modify their existing systems. Both hot tapping and cold tapping procedures have been used to create new connections. In a cold tapping procedure, a portion of the system is shut down and the gas in the desired section of the pipeline is purged into the atmosphere to ensure that a safe connection is made. Cold tapping procedures can result in methane emissions, loss of product and sales, customer inconvenience, and the increased costs associated with evaluating the desired section of the system.

In hot tapping procedures, the desired section of the pipeline is not shut down. Instead, the new connection is made while the pipeline remains in service and natural gas continues to flow under pressure within the pipe. The hot tapping procedure involves attaching a branch connection and valve on the outside of the operating pipeline, and then cutting out the pipe wall within the branch and removing the wall section through the valve.

### SUMMARY

This application describes tapping devices and methods for using such devices to tap into a pipe. The tapping device contains a drill connected to the proximal portion of a shaft, a tapping tool attached to a distal portion of the shaft, and a protection device attached to the shaft. The protection device itself contains containing an enlarged distal portion, an enlarged proximal portion, and a middle member extending therebetween. The user can hold and use the tapping device with a first hand on a handle of the drill and a second hand on the middle member of the protection device. The protection device protects the hand from hitting an object (including the pipe), the socket, or the drill, thereby improving the safety for the user.

### BRIEF DESCRIPTION OF THE DRAWINGS

The following description can be better understood in light of the Figures, in which:

FIG. 1 depicts some embodiments of a tapping device;

FIG. 2 depicts some embodiments of a protection device that is part of the tapping device;

FIG. 3 depicts other embodiments of the protection device;

FIGS. 4a, 4b, and 4c depict some embodiments of the configurations for the outer surface of the protection device;

FIGS. 5a and 5b depict some embodiments of a sleeve that can be used in the gap between the protection device and a shaft of the tapping device;

FIG. 6 depicts some embodiments of a stopping member that is part of the tapping device;

FIG. 7 depicts other embodiments of the stopping member that is part of the tapping device; and

FIG. 8 depicts some embodiments of methods for using the tapping device.

The Figures illustrate specific aspects of the tapping devices and methods for using such devices to tap into a pipe. Together with the following description, the Figures demonstrate and explain the principles of the structures, methods, and principles described herein. In the drawings, the thickness and size of components may be exaggerated or otherwise modified for clarity. The same reference numerals in different drawings represent the same element, and thus their descriptions will not be repeated. Furthermore, well-known structures, materials, or operations are not shown or described in detail to avoid obscuring aspects of the described devices. Moreover, the Figures may show simplified or partial views, and the dimensions of elements in the Figures may be exaggerated or otherwise not in proportion for clarity.

### DETAILED DESCRIPTION

The following description supplies specific details in order to provide a thorough understanding. Nevertheless, the skilled artisan will understand that the tapping devices and associated methods of making and using the tapping devices can be implemented and used without employing these specific details. Indeed, the tapping devices and associated methods can be placed into practice by modifying the described devices and methods and can be used in conjunction with any other apparatus and techniques conventionally used in the industry. For example, while description refers to tapping devices used to tap into a gas pipe, it could be modified and used to safely tap into other pipes. Indeed, the protection device could be used as an add-on feature to protect a user in other tools that contain shafts, and can be installed on any shaft for the purpose of removing or installing other objects like drill bits and grounding bars.

As the terms on, attached to, or coupled to are used herein, one object (e.g., a material, a layer, a substrate, etc.) can be on, attached to, or coupled to another object regardless of whether the one object is directly on, attached, or coupled to the other object or there are one or more intervening objects between the one object and the other object. Also, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

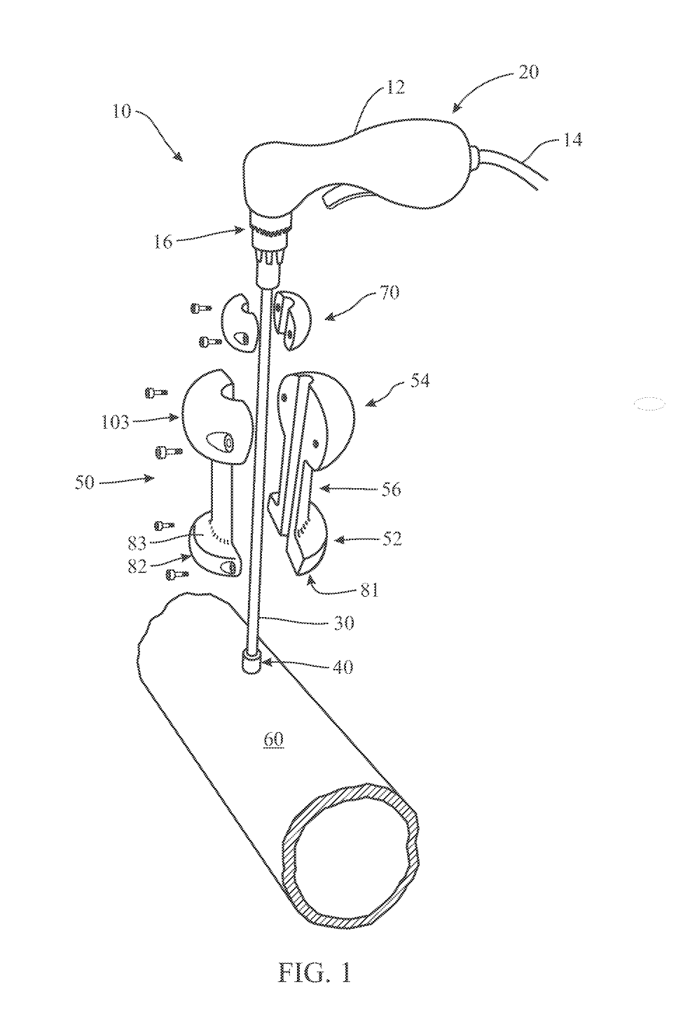

Some embodiments of the tapping devices and methods for using such devices are described herein and illustrated in the Figures. As shown in FIG. 1, the tapping devices 10 contain a drill (such as air drill 20) that can be connected to a proximal part of a shaft 30. A tapping tool 40 can be connected to the distal part of the shaft 40. A protecting device 50 can be removably connected to the shaft 30. The tapping device is used to tap into a pipe 60.

The drill used in the tapping device 10 can be any drill used in tapping procedures. Examples of such drills include power drills or air-powered drills (or air drills). In some embodiments, and as illustrated in FIG. 1, an air drill 20 can be used as the drill. The air drill 20 contains a handle 12 where a user can grab and hold the drill during operation. The handle can be configured as known in the art with and shape, size, and surface texture suited for a user's hand.

The base of the handle 12 is connected to a hose 14. The hose 14 typically contains pressurized air which is used to power the air drill. The air typically can be kept at any normal operating pressure known in the art. The hose 14 can be connected to the handle using any connection known the art. The other end of the hose 14 can be connected to a compressor (not shown) that keeps the air within the desired pressure range.

As shown in FIG. 1, the top of the handle 14 of the air drill contains a socket 16. The socket 16 can be connected to the shaft 30. The socket 16 can be configured as known in the art so it can be connected to the desired shaft 30 that will be used in the tapping device. In some embodiments, the socket 16 comprises an air drill socket.

The shaft 30 of the tapping device 10 can be configured to be used with the desired drill and the desired tapping tool. The shaft 30 can also be configured to withstand the pressures and forces that will be placed on the shaft during the tapping process. In the embodiments depicted in the Figures, the shaft can be configured with a circular cross section, any diameter, and any length that can provide the support and strength to tap into the desired object using the drill. The shaft 30 can also be made of any material, including metals like steel.

In some embodiments, the shaft 30 can be connected to a tapping tool 40. In other embodiments, the tapping tool 40 and the shaft 30 can be manufactured with the tapping tool 40 already formed at its end. In both embodiments, the tapping tool 40 comprises an outer periphery with a hollow inner portion, as known in the art. The outer periphery comprises any known cutting surface that cuts into the gas pipe as the air drill rotates the shaft 30 and, in turn, the shaft rotates the tapping tool 40. As it rotates and cuts, the tapping tool 40 will eventually cut through the wall of the pipe 60 and create a hole with a size similar to the outer diameter of the tapping tool. The diameter of the tapping tool 40 can therefore be selected with the desired size of the hole needed in the gas pipe.

The tapping device 10 also contains a protection device 50. As shown in FIG. 1, the protection device 50 contains an enlarged distal portion 52, an enlarged proximal portion 54, and a middle section 56 extending therebetween. The middle section 56 can be gripped and held by the user while the tapping device 10 is moved to the desired location of the pipe 60 and tehn operated. Accordingly, the middle section 56 can be configured to be easily held and/or gripped by the user.

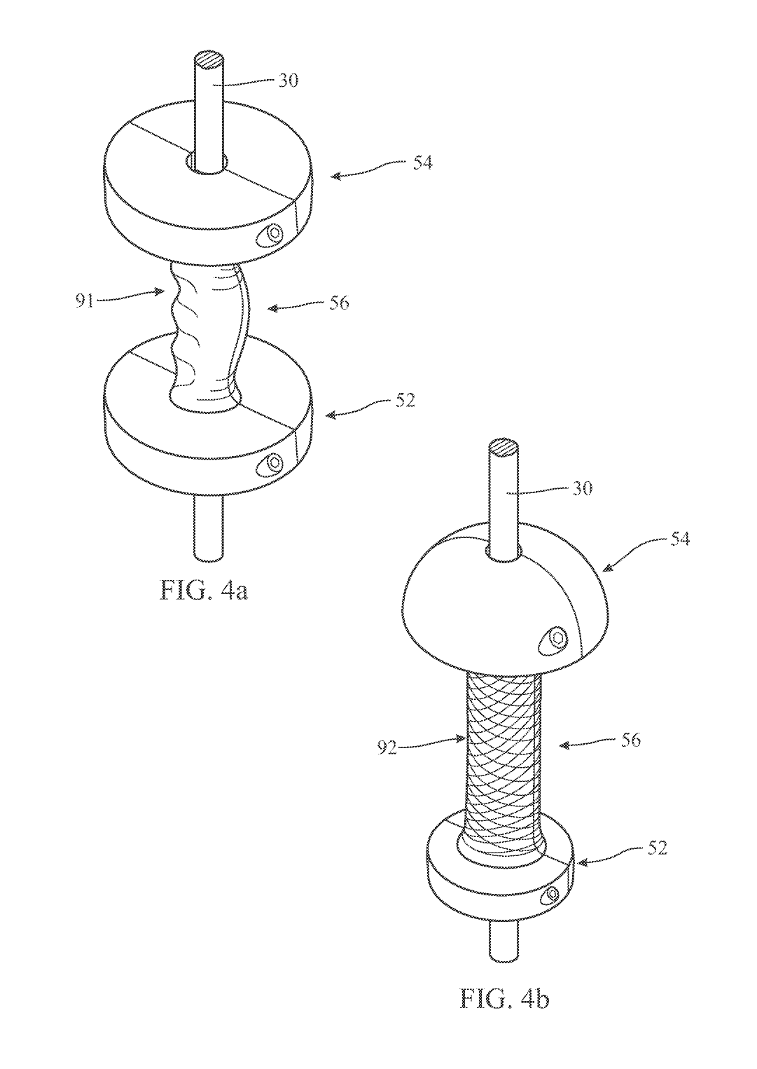

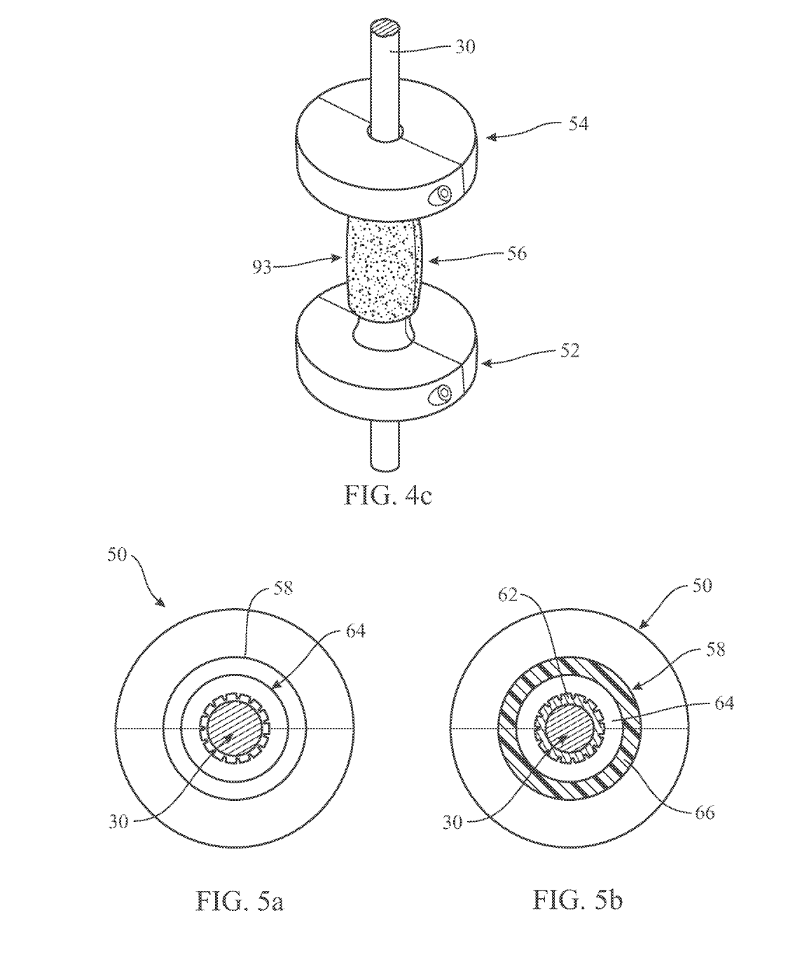

In the embodiments illustrated in FIG. 1, the middle section 56 is depicted as have a substantially circular outer surface with a substantially similar outer diameter along its length. The middle section 56 can have other shapes, including polygonal, triangular, or rectangular. As well, the diameter need not be substantially similar along the length of the middle section and can increase, or decrease, as needed. In some embodiments, the middle section 56 can be provided with indentations 91 where the fingers of a user's hand can be located, as shown in FIG. 4a.

In the embodiments depicted in FIG. 1, the middle section 56 is illustrated as containing a smooth outer surface. In other embodiments, though, part or all of the outer surface of the middle section can contain a non-smooth surface 92 with irregularities, as shown in FIG. 4b, that increase the ability of the user to grip the outer surface of the middle section. In yet other embodiments, as shown in FIG. 4c, a coating or other gripping surface 93 can be applied to part or all of the outer surface of the middle section, making it easier to grip for a user handling and operating the tapping device. The diameter and length of the outer surface of the middle section 56 can be configured with any length and diameter to fit a desired user's hand.

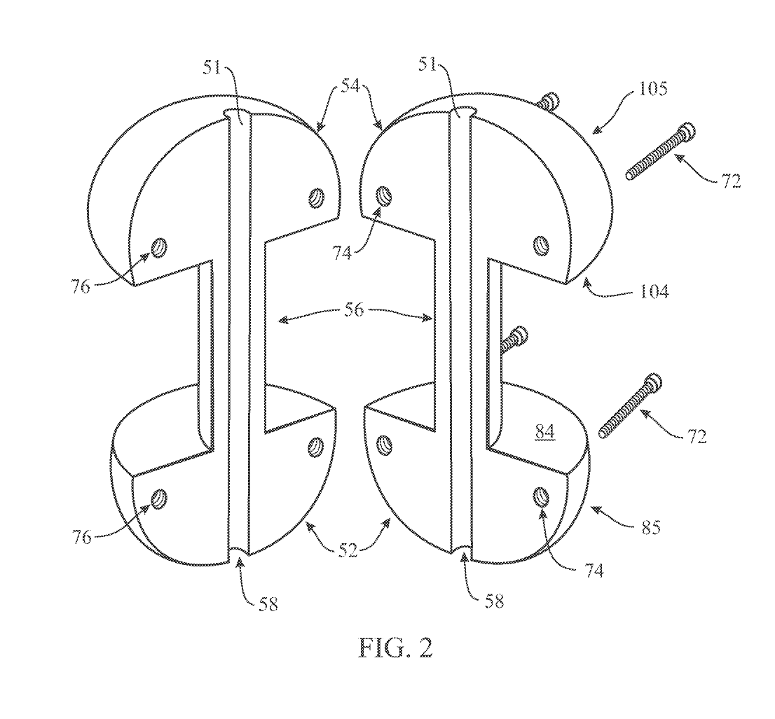

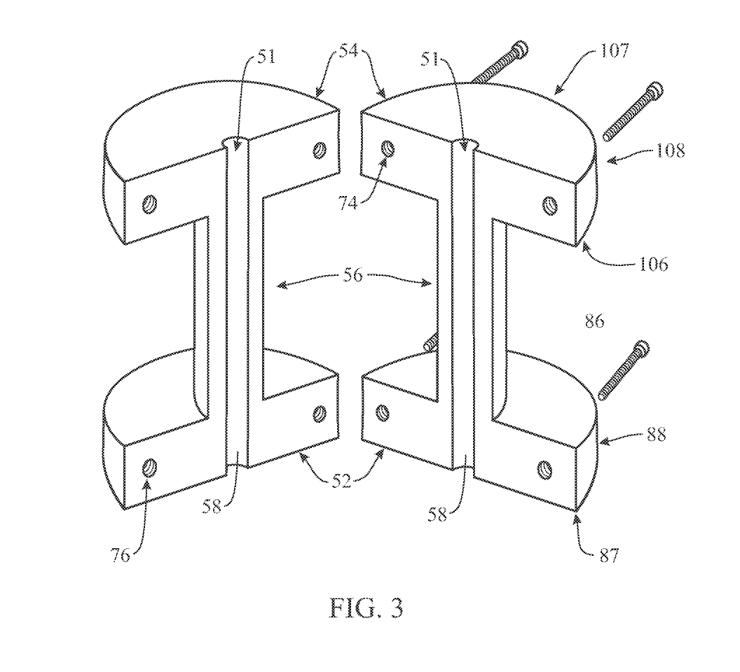

The protection device 50 contains a distal portion 52 that is enlarged relative to the middle section. The distal portion 52 prevents (or reduces) the user's hand from slipping off the middle section towards the tapping tool 40. Accordingly, the distal potion 52 can be configured with any shape or size that accomplishes this purpose. In the embodiments illustrated in FIG. 1, the distal portion can be configured with a substantially flat end 81, an edge 82, and a curved section 83 that extends from the middle section to the edge 82. In the embodiments illustrated in FIG. 2, the distal portion can be configured with a substantially flat end 84 and a curved section 85 that extends from that end to the edge. In other embodiments, the distal portion can be configured with a first substantially flat end 86 and an opposite second substantially flat end 87 that are separate by an edge 88 as illustrated in FIG. 3.

The protection device 50 also contains a proximate portion 54 that is enlarged relative to the middle section 56. The proximal portion 54 prevents (or reduces) the ability of the user's hand from slipping off the middle section towards the drill. Accordingly, the proximal portion 54 can be configured with any shape or size that accomplishes this purpose. The proximate portion can be configured substantially similar to or the distal portion, as shown in FIGS. 2 and 3, or different than the distal portion, as shown in FIG. 1. In the embodiments illustrated in FIG. 1, the proximal portion can be configured a curved section 103 that extends from the middle section to the edge. In the embodiments illustrated in FIG. 2, the proximal portion can be configured with a substantially flat end 104 and a curved section 105 that extends from that end to the edge. In other embodiments, the proximal portion can be configured with a first substantially flat end 106 and an opposite second substantially flat end 107 that are separate by an edge 108 as illustrated in FIG. 3.

In some embodiments, the protection device 50 can be removably attached to the shaft 30. In these embodiments, the protection device 50 can be separated into two parts as shown in FIGS. 1-3. The two parts are then connected to each other using any removable connection device. In the embodiments illustrated in FIGS. 1-3, this connection device includes screws 72 which slide through holes 74 (optionally with grooves) in one of these parts and then screw into mating connections 76 containing grooves in the other part. Other connection devices like clamping mechanisms can be used in place of, or in addition, to the screws and mating connections.

In other embodiments, the protection device 50 can be permanently attached to the shaft 30. In these embodiments, the protection device can be separated into two parts as shown in FIGS. 1-3. The two parts can then be connected to each other using any permanent connection device, like welding the two parts together. Since the two parts can no longer be removed from each other, the protection device 50 is therefore permanently attached to a specific location of the shaft 30.

In some configurations, the inner surface 51 of the protection device 50 can be configured to fit around the shaft 30. Thus, the inner surface of the protection device 50 contains an indentation 58 substantially matching the outer surface of the shaft 30. In the embodiments depicted in FIGS. 1-3, the shaft 30 has a substantially circular outer surface and so the indentations 58 on the inner surface 51 of the protection device have a matching, substantially circular shape along the length thereof.

In some embodiments, the inner surface 51 of the protection device 50 can be configured to leave a slight gap 64 between the indentations 58 and the shaft 30, as shown in FIG. 5a. Thus, the protection device 50 can be retained on the shaft 30 by the user without any force applied, while also being able to slide along the length of the shaft by applying sufficient force. The force needed to move the protection along the shaft 30 could be any normal force that is typically applied by a user. In other embodiments, though, no such gap is created and the protection device 50 does not slide or move along the length of the shaft 30. In yet other embodiments, the gap 64 can be configured so that only a negligible force is needed to slide the protection device along the length of the shaft.

Optionally, the tapping device 10 can contain an inner sleeve 62 and/or and an outer sleeve 66, as shown in FIG. 5b. The inner and/or outer sleeve can be placed in the gap 64 described above, thereby reducing the size of the gap 64 or, in some configurations, eliminating the gap. Using the inner and/or outer sleeve allows a single protection device 50 with a single diameter to be used with multiple sizes of shafts. The inner and/or outer sleeve can be configured to reduce the gap between that single protection device and the actual shaft it is used with. The inner and/or outer sleeve can be made of any material, whether the same or different from each other, including brass. In some embodiments, multiple inner and/or outer sleeves of varying diameters could be used to substantially eliminate this gap, temporarily fixing a specific protection device to a specific location of a desired shaft.

The protection device 50 can be made of any known material that, with the structure described, will add protection to the hand of a user. In some embodiments, the protection device can be made of ceramic materials, composite materials, and metals like steel, or brass. The protection device can also be made using any combination of these materials.

In some configurations, the tapping device 10 also contains a stopping member that prevents the protection device from moving beyond a specific location along the shaft. In some embodiments, that stopping member can be located close to the drill so that the protection device is prevented from contacting the drill, preventing damage to the drill and to the user. One example of such a location is illustrated in FIG. 1. In other embodiments, a stopping member can also, or instead, be located close to the tapping tool so that the protection device is prevented from contacting the tapping tool, preventing damage to the drill and to the user.

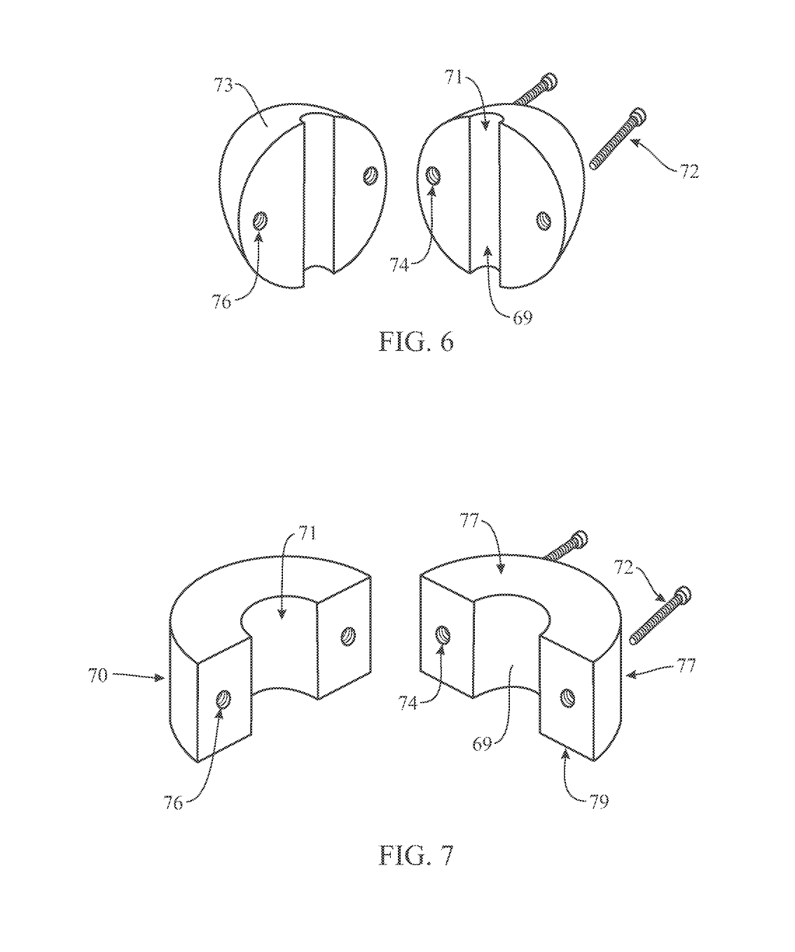

The stopping member can have any configuration consistent with this stopping function. In the embodiments illustrated in FIGS. 1 and 6, the stopping member comprises a nipple 70 being configured with a substantially curved outer surface 73. In other embodiments, as shown in FIG. 7, the nipple 70 can be configured with an edge 75, a first flat end 77, and a second flat end 79 opposite the first flat end.

In some embodiments, the nipple 70 can be removably attached to the shaft 30. In these embodiments, the nipple can be separated into two parts as shown in FIGS. 1 and 6-7. The two parts can then be connected to each other using any removable connection device. In the embodiments illustrated in FIGS. 1 and 6-7, this connection device includes screws 72 which slide through holes 74 (optionally with grooves) in one of these two parts and then screw into mating connections 76 with grooves in the other part of the nipple. Other connection devices like clamping mechanisms can be used in place of, or in addition, to the screws and mating connections.

In other embodiments, the nipple 70 can be permanently attached to the shaft 30. In these embodiments, the nipple can be separated into two parts as shown in FIG. 1. The two parts can then be connected to each other using any permanent connection device, like welding the two parts together. Since the two parts can no longer be removed from each other, the nipple is therefore permanently attached to the shaft 30 in that specific location.

The inner surface 69 of the nipple 70 can be configured to fit around the shaft 30. Thus, the inner surface 69 contains an indentation 71 substantially matching the outer surface of the shaft 30. In the embodiments depicted in FIG. 1, the shaft 30 has a substantially circular outer surface and the indentations 71 of the nipple 70 have a matching, substantially circular shape along the length thereof. In some embodiments, the nipple 70 can be designed to not slide along the shaft 30. Accordingly, the indentations 71 can be configured so that they accomplish this purpose. In other embodiments, sleeves (similar to the sleeves used for the protection device 50) can be used to fix the nipples to a single location on the shaft.

The tapping device 10 can be assembled using any process that forms the structures described above. In some embodiments, the tapping device can be assembled by connecting or attaching the tapping tool to the distal end of the shaft. The proximal end of the shaft is then connected to the drill using any process known in the art and secured to the drill using the socket 16. The separated parts of the nipple 70 can then be situated along the desired part of the shaft 30 and can be connected to each other using the connection device. The separated parts of the protection device are then connected to each other using the connection device.

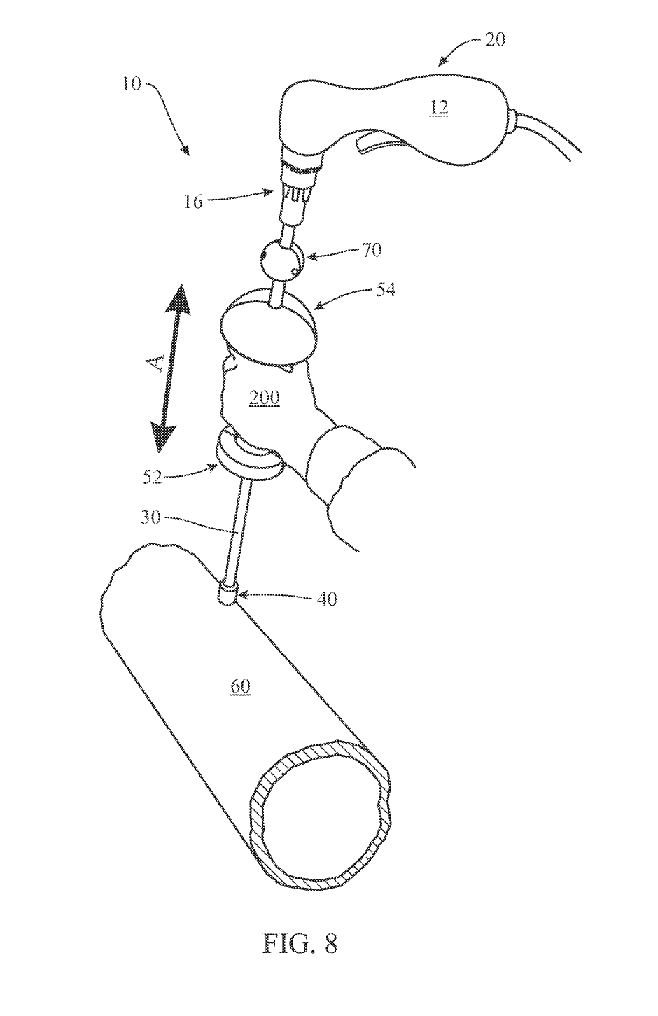

Once assembled, the user grasps the handle of the drill with a first hand (not shown) and the middle section of the protection device with a second hand 200, as shown in FIG. 8. The tapping tool can then be placed against the desired location of the pipe and the drill is turned on. As illustrated in FIG. 8, the protection device 50 can be slid closer to the tapping device (along direction -A-) to add additional pressure during the tapping procedure. Once the pipe has been tapped, the protection device 50 can be pulled away from the pipe 60 and slid closer to the nipple 70 (along direction -A-) to help remove the tapping device 10 (including the tapping tool 40) out of and away from the pipe 60.

The protection device 50 allows better control during tapping procedure. It allows the user to effectively hold the shaft 30 closer to the tapping location of the pipe, allowing better placement of the tapping tool, increased pressure during the tapping procedure, and easier removal from the pipe once the tapping process is completed. As well, the protection device 50 increases the safety of the user. It prevents—or reduces the chance—of a user's hand contacting the drill, shaft, or pipe during the tapping process, which contact can cause injury to the user.

In some variations of the tapping devices, two or more protection devices could be added to a single shaft. Such a modification could be used when larger tapping devices are used or where more than a single person are operating the device.

In addition to any previously indicated modifications, those skilled in the art may devise numerous other variations and alternative arrangements without departing from the spirit and scope of this description. The appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A tapping device, comprising:
a drill connected to a proximal portion of a shaft;
a tapping tool connected to a distal portion of the shaft; and
a protection device retained to the shaft, the protection device containing an enlarged distal portion, an enlarged proximal portion, and a middle section extending therebetween.

2. The device of claim 1, wherein the protection device is removably retained to the shaft.

3. The device of claim 1, further comprising a stopping member affixed to the shaft proximate the drill.

4. The device of claim 1, wherein the middle section is configured to retain the hand of a user between the proximal portion and the distal portion of the protection device.

5. The device of claim 1, wherein the protection device contains an inner surface with an indentation substantially matching the outer surface of the shaft.

6. The device of claim 1, wherein the protection device comprises two separate parts that can be connected to each other around the shaft.

7. The device of claim 1, wherein the enlarged distal portion is configured substantially similar to the enlarged proximal portion.

8. The device of claim 3, wherein the stopping member comprises two separate parts that can be connected to each other around the shaft.

9. The device of claim 2, wherein the protection device comprises two separate parts that can be connected to each other around the shaft.

10. The device of claim 1, wherein the protection device is permanently retained to the shaft.

11. A hand protector used in a tapping device, comprising:
an enlarged distal portion;
an enlarged proximal portion; and
a middle section extending therebetween;
wherein the protection device is retained to a shaft that is connected at a proximal end to a drill and at a distal end to a tapping tool.

12. The hand protector of claim 11, wherein the protection device is removably retained to the shaft.

13. The hand protector of claim 11, wherein the middle section is configured to retain the hand of a user between the proximal portion and the distal portion of the protection device.

14. The hand protector of claim 11, wherein the protection device contains an inner surface with an indentation substantially matching the outer surface of the shaft.

15. The hand protector of claim 11, wherein the protection device comprises two separate parts that can be connected to each other around the shaft.

16. The hand protector of claim 11, wherein the enlarged distal portion is configured substantially similar to the enlarged proximal portion.

17. The hand protector of claim 12, wherein the protection device comprises two separate parts that can be connected to each other around the shaft.

18. The hand protector of claim 11, wherein the protection device is permanently retained to the shaft.

19. A method for tapping a pipe, comprising:
connecting a drill to a proximal portion of a shaft;
connecting a tapping tool to a distal portion of the shaft;
retaining a protection device to the shaft, the protection device containing an enlarged distal portion, an enlarged proximal portion, and a middle section extending therebetween; and
holding a first hand on the drill and a second hand on the protection device while operating the drill to tap a pipe.

20. The process of claim 19, wherein the protection device is removably retained to the shaft.

21. The process of claim 19, further comprising a stopping member affixed to the shaft proximate the drill.

22. The process of claim 19, wherein the middle section is configured to retain the hand of a user between the proximal portion and the distal portion of the protection device.

23. The process of claim 19, wherein the protection device contains an inner surface with an indentation substantially matching the outer surface of the shaft.

24. The process of claim 19, wherein the protection device comprises two separate parts that can be connected to each other around the shaft.

25. The process of claim 19, wherein the enlarged distal portion is configured substantially similar to the enlarged proximal portion.
